(19) United States
(12) Patent Application Publication
(10) Pub. No.: US 2025/0170911 A1
(43) Pub. Date: May 29, 2025

(54) CONVERSION ADAPTER

(71) Applicant: TOYOTA JIDOSHA KABUSHIKI KAISHA, Toyota-shi (JP)

(72) Inventor: Noriaki ABURAI, Toyota-shi (JP)

(73) Assignee: TOYOTA JIDOSHA KABUSHIKI KAISHA, Toyota-shi (JP)

(21) Appl. No.: 18/790,303

(22) Filed: Jul. 31, 2024

(30) Foreign Application Priority Data
Nov. 29, 2023 (JP) 2023-201805

(51) Int. Cl. B60L 53/16; B60L 53/60; H02J 7/00

(52) U.S. Cl. CPC B60L 53/16; B60L 53/60; H02J 7/00309

(57) ABSTRACT

A conversion adapter that is interposed between a charging inlet that receives power supply for charging a battery included in a vehicle and a charging plug that is connected to a charging facility outside the vehicle and enables power supply from the charging plug toward the charging inlet, the conversion adapter including an overheat protection unit that stops the charging when a temperature of a predetermined heat generation portion exceeds a predetermined threshold value.

### CROSS-REFERENCE TO RELATED APPLICATION

This application claims priority to Japanese Patent Application No. 2023-201805 filed on Nov. 29, 2023, incorporated herein by reference in its entirety.

### BACKGROUND

### 1. Technical Field

The technology disclosed herein relates to a conversion adapter to be interposed between a charging inlet and a charging plug.

### 2. Description of Related Art

When there is a difference in standard between a charging inlet that receives power supply for charging a battery of a vehicle and a charging plug to be connected to a charging facility outside the vehicle, a conversion plug is interposed between the charging inlet and the charging plug to enable power supply from the charging plug to the charging inlet.

Japanese Unexamined Patent Application Publication No. 2017-229230 (JP 2017-229230 A) discloses an adapter in which there is a difference in standard between an input-side socket for accommodating a connector that extends from a charging station and an output-side connector to be connected to an electrified vehicle.

### SUMMARY

Even in a state in which the conversion adapter is interposed between the charging inlet and the charging plug, the allowable current value for a current supplied from the charging facility to the vehicle is determined through communication between the charging facility and the vehicle. Therefore, when the allowable current value of the conversion adapter is smaller than the allowable current value determined as described above, there is a possibility that an overcurrent flows through the conversion adapter and the conversion adapter is overheated. The present specification provides a technique of addressing this issue.

An aspect of this specification provides an conversion adapter to be interposed between a charging inlet that receives power supply for charging a battery of a vehicle and a charging plug to be connected to a charging facility outside the vehicle, to enable power supply from the charging plug toward the charging inlet.

The conversion adapter includes an overheat protection unit that stops charging when a temperature of a predetermined heat generating portion exceeds a predetermined threshold value.

According to the above configuration, the overheat protection unit of the conversion adapter stops charging when the temperature of the predetermined heat generating portion exceeds a predetermined threshold value. Consequently, overheating of the conversion adapter due to an overcurrent can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified diagram of a charging system;

FIG. 2 shows a conversion adapter according to a first embodiment;

FIG. 3 shows a conversion adapter according to a second embodiment;

FIG. 4 shows a conversion adapter according to a third embodiment;

FIG. 5 is a diagram showing the relation between the temperature and the resistance of the thermo-variable resistance; and

FIG. 6 is a flow chart for overheat protection.

### DETAILED DESCRIPTION OF EMBODIMENTS

Embodiments will be described with reference to the drawings. Each of the drawings is merely an example, and the present embodiment is not limited to the illustrated contents. In addition, since each of the drawings is an example, the illustrated shape is not accurate or a part thereof is omitted.

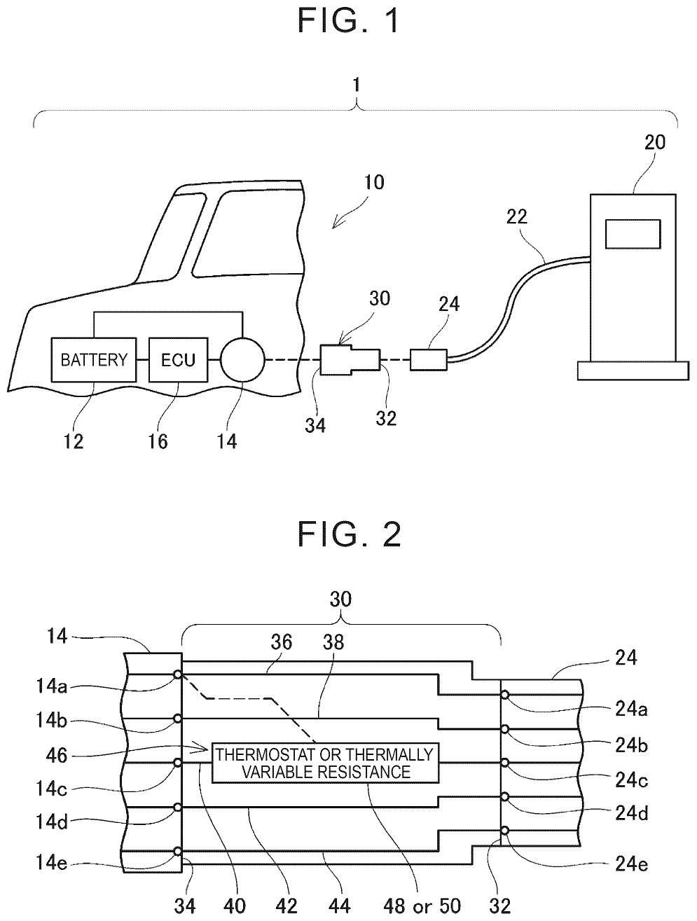

FIG. 1 shows a charging system 1 in a simplified manner. The charging system 1 includes a vehicle 10, a charging facility 20 outside the vehicle, a charging plug 24, and the like. The vehicles 10 are electrified vehicle. Electrified vehicle is, for example, a battery electrified vehicle or a plug-in hybrid electrified vehicle, and includes a battery 12 that can be charged and discharged by an external power source, and a traveling motor (not shown) that is supplied with electric power from the battery 12. Further, the vehicle 10 includes a charging inlet 14 that receives electric power for charging the battery 12, and a ECU 16. ECU is an abbreviation for Electronic Control Unit. ECU 16 is one of various ECU mounted on the vehicles 10, and is, for example, an ECU for controlling the charge of the battery 12.

The charging facility 20 is a AC type power supply device. A charging cable 22 extends from the charging facility 20, and a leading end of the charging cable 22 serves as a charging plug 24. Usually, the user attaches the charging plug 24 to the charging inlet 14, thereby connecting the charging facility 20 and the vehicle 10 with the charging cable 22 to charge the battery 12. However, when the standard such as the socket shape of the charging inlet 14 is different from the standard such as the shape of the charging plug 24, the charging plug 24 cannot be directly attached to the charging inlet 14. To overcome such differences in standards, the user uses the conversion adapter 30. The standard of each of the charging inlet 14 and the charging plug 24 is not particularly limited, and for example, a known one may be adopted.

The conversion adapter 30 has an input-side socket 32 corresponding to the standard of the charging plug 24 and an output-side plug 34 corresponding to the standard of the charging inlet 14. Therefore, the user attaches the charging plug 24 to the input-side socket 32 of the conversion adapter 30, and attaches the output-side plug 34 of the conversion adapter 30 to the charging inlet 14. As a result, the conversion adapter 30 is interposed between the charging plug 24 and the charging inlet 14 to enable power supply from the charging plug 24 to the charging inlet 14.

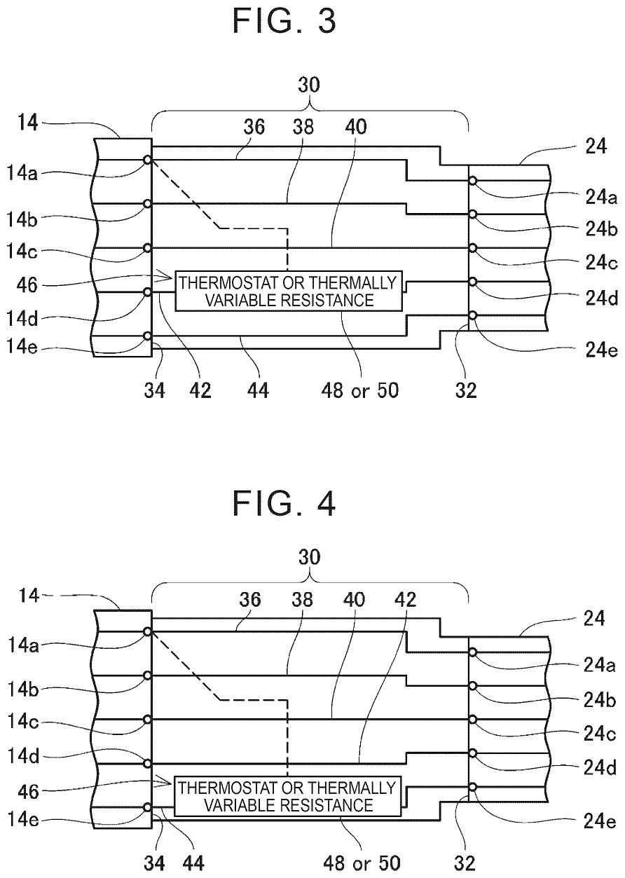

FIG. 2, FIG. 3, and FIG. 4 each show a conversion adapter 30 interposed between the charging plug 24 and the charging inlet 14. The configuration illustrated in FIG. 2 is referred to as a first embodiment, the configuration illustrated in FIG. 3 is referred to as a second embodiment, and the configuration illustrated in FIG. 4 is referred to as a third embodiment. Any of the first, second, and third embodiments may be employed. The conversion adapter 30 includes a first power line 36, a second power line 38, a CPLT signal line 40, a connection signal line 42, and a ground signal line 44 as signal lines connecting the input-side socket 32 and the output-side plug 34. CPLT is an abbreviation for control-pilot.

The positive first power line 36 connects the first positive terminal 24a of the power line included in the charging plug 24 to the second positive electrode terminal 14a of the power line included in the charging inlet 14. Similarly, the negative second power line 38 connects the first negative terminal 24b of the power line included in the charging plug 24 and the second negative terminal 14b included in the charging inlet 14. CPLT signal line 40 connects the first CPLT terminal 24c of the charging plug 24 to the second CPLT terminal 14c of the charging inlet 14. CPLT signal is a control signal exchanged between the charging facility 20 and ECU 16 of the vehicle 10, and for example, an allowable current is indicated by a CPLT signal from the charging facility 20 to the vehicle 10. CPLT signal line 40 mediates transmission of such a CPLT signal. Since this allowable current value is a value determined in the relationship between the charging facility 20 and the vehicle 10, it may be too large for the conversion adapter 30.

The connection signal line 42 connects the first connection terminal 24d of the charging plug 24 and the second connection terminal 14d of the charging inlet 14, and mediates transmission of a connection signal indicating a connection status between the charging plug 24 and the charging inlet 14. ECU 16 can determine whether or not the charging inlet 14 and the charging plug 24 are connected in accordance with the level of the connection signal inputted from the second connection terminal 14d. The ground signal line 44 connects the first ground terminal 24e of the charging plug 24 to the second ground terminal 14e of the charging inlet 14, and serves as a part of the ground line.

The conversion adapter 30 includes an overheat protection unit 46 that stops the charging when the temperature of a predetermined heat generating portion exceeds a predetermined threshold value. As described above, the conversion adapter 30 has several signal lines connecting the terminals of the charging inlet 14 and the terminals of the charging plug 24.

As shown in FIG. 2, according to the first embodiment, the overheat protection unit 46 includes a thermostat 48 provided on CPLT signal line 40. The thermostat 48 is a circuit that switches the switch off when the temperature of the detection target rises, and switches the switch on when the temperature of the detection target falls.

The predetermined heat generation portion is a portion of the conversion adapter 30 that is likely to increase in temperature due to an overcurrent. As the heat generating portion, for example, a predetermined terminal in which the input-side socket 32 is in contact with the charging plug 24, a predetermined terminal in which the output-side plug 34 is in contact with the charging inlet 14, and a conductor such as a bus bar for flowing a current are assumed. For example, as illustrated by a chain line, the thermostat 48 acquires the temperature of the heat generating portion using the contact portion between the second positive electrode terminal 14a and the output-side plug 34 as the heat generating portion. For example, the thermostat 48 acquires the detected temperature of the heat generating portion detected by a temperature sensor (not shown). Such a configuration including the temperature sensor or the thermostat 48 may be regarded as the overheat protection unit 46.

The thermostat 48 shuts off CPLT signal line 40 when the detected temperature exceeds a preset threshold. When ECU 16 detects that CPLT signal is stopped due to the interruption of CPLT signal line 40, the vehicle 10 stops charging the battery 12 with the electric power supplied through the charging inlet 14.

As shown in FIG. 3, according to the second embodiment, the overheat protection unit 46 includes a thermostat 48 provided on the connection signal line 42. The thermostat 48 shuts off the connection signal line 42 when the detected temperature exceeds the threshold value. On the vehicle 10 side, if ECU 16 detects the interruption of the connection signal line 42, it may be stopped charging the battery 12 of the power supplied through the charging inlet 14. When viewed from ECU 16, the disconnection of the connection signal line 42 is the same as that in which the connection of the charging plug 24 cannot be detected.

As shown in FIG. 4, according to the third embodiment, the overheat protection unit 46 includes a thermostat 48 provided on the ground signal line 44. The thermostat 48 shuts off the ground signal line 44 when the sensed temperature exceeds a threshold value. On the vehicle 10 side, ECU 16 may cease to charge the battery 12 of the power supplied via the charging inlet 14 if it detects the interruption of the ground signal line 44.

The interruption of the signal line by the thermostat 48 as described above may be detected by the controller on the charging facility 20 side, and the charging of the battery 12 may be stopped by the charging facility 20 stopping the power supply. According to each of these embodiments, when the temperature of the heat generating portion exceeds the threshold value, the overheat protection unit 46 shuts off the signal line included in the conversion adapter 30, thereby causing the vehicle 10 or the charging facility 20 to stop the charging. That is, the interruption of the signal line by the thermostat 48 results in an instruction to stop the charging to the vehicle 10 or the charging facility 20, and the vehicle 10 or the charging facility 20 stops the charging.

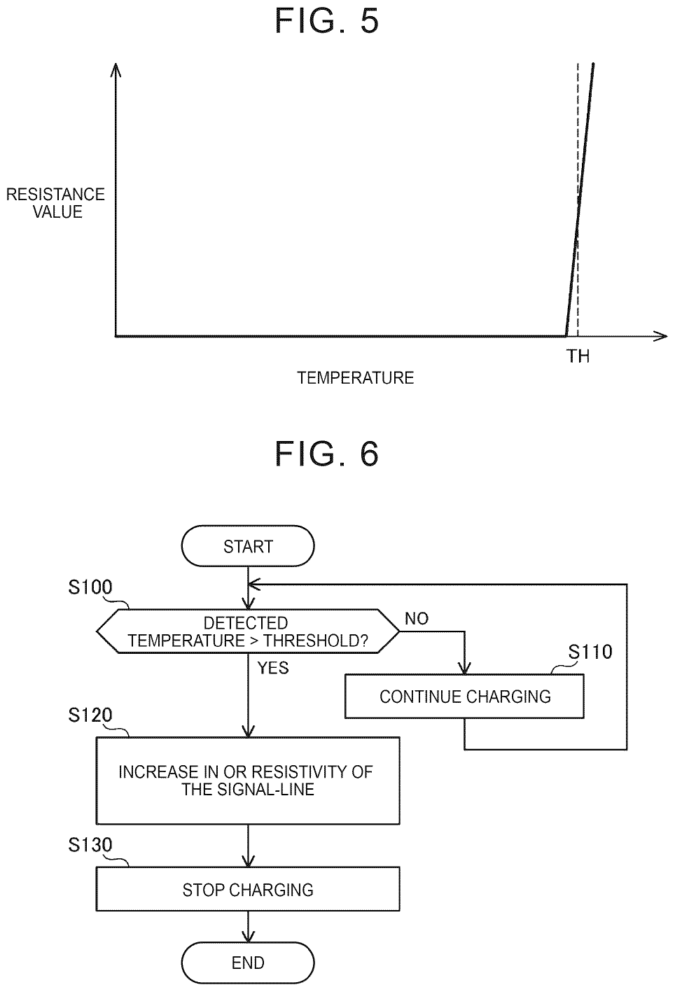

Any of the embodiments described above can be interpreted by replacing the thermostat 48 with a thermally variable resistance 50. The thermally variable resistance 50 is a resistance element that changes a resistance value in accordance with a temperature of a detection target. As illustrated in FIG. 5, the thermally variable resistance 50 abruptly increases the resistance value when the temperature of the detection target exceeds the temperature TH that is the threshold value.

That is, in the first embodiment, the overheat protection unit 46 may include the thermally variable resistance 50 provided on CPLT signal line 40. The thermally variable resistance 50 increases the resistance of CPLT signal line 40 when the detected temperature exceeds the threshold. The charging facility 20 has a mechanism in which, for example, when the resistive value of CPLT signal line 40 changes, the voltage value of CPLT signal line 40 to be monitored increases. When such an increase in the voltage value is recognized, the charging facility 20 stops power supply to stop charging the battery 12.

Similarly, in the second embodiment, the overheat protection unit 46 may include the thermally variable resistance 50 provided on the connection signal line 42. The thermally variable resistance 50 increases the resistance value of the connection signal line 42 when the detected temperature exceeds the threshold value. On the vehicle 10 side, ECU 16 decides to decrease the allowable current value when, for example, an increase in the resistive value of the connection signal line 42 is detected. Then, ECU 16 stops charging the battery 12 with the electric power supplied through the charging inlet 14 in accordance with such a determination.

Similarly, in the third embodiment, the overheat protection unit 46 may include the thermally variable resistance 50 provided on the ground signal line 44. The thermally variable resistance 50 increases the resistance value of the ground signal line 44 when the detected temperature exceeds the threshold value. When ECU 16 detects an increase in the resistance of the ground signal line 44, the vehicle 10 stops charging the battery 12 with the electric power supplied through the charging inlet 14.

According to each such embodiment, when the temperature of the heat generating portion exceeds the threshold value, the overheat protection unit 46 causes the vehicle 10 or the charging facility 20 to stop the charging by increasing the resistance value of the signal line included in the conversion adapter 30. That is, the increase in the resistance value of the signal line by the thermally variable resistance 50 results in an instruction to stop the charging of the vehicle 10 or the charging facility 20, and the vehicle 10 or the charging facility 20 stops the charging.

FIG. 6 is a flowchart showing the overheat protection of the present embodiment executed in the charging system 1 in a state where the conversion adapter 30 is interposed between the charging plug 24 and the charging inlet 14.

After the battery 12 starts charging, the overheat protection unit 46 of the conversion adapter 30 acquires the detected temperature of the heat generating portion and branches the process according to whether or not the detected temperature exceeds a threshold value (S100). If the detected temperature does not exceed the threshold value (“No” in S100), the charge is continued as it is (S110), and the determination of S100 is repeated.

When the detected temperature exceeds the threshold value (“Yes” in S100), the overheat protection unit 46 shuts off the predetermined signal-line of the conversion adapter 30 or S120 the resistance-value as described above. The vehicle 10 or the charging facility 20 regards this as an instruction to stop the charging, and stops the charging of the battery 12 (S130).

As described above, according to the present embodiment, a conversion adapter 30 is disclosed that is interposed between the charging inlet 14 that receives power supply for charging the battery 12 included in the vehicle 10 and the charging plug 24 that is connected to the charging facility 20 outside the vehicle, and enables power supply from the charging plug 24 to the charging inlet 14. The conversion adapter 30 includes an overheat protection unit 46 that stops the charging when the temperature of a predetermined heat generating portion exceeds a predetermined threshold value. According to this configuration, even if an excessive current flows temporarily to the conversion adapter 30 during charging of the battery 12, the charging can be stopped by the action of the overheat protection unit 46, and the conversion adapter 30 can be suppressed from becoming overheated.

Further, according to the present embodiment, the conversion adapter 30 has a signal line connecting the terminal of the charging inlet 14 and the terminal of the charging plug 24, and the overheat protection unit 46 shuts off the signal line when the temperature of the heat generating portion exceeds the threshold value, thereby causing the vehicle 10 or the charging facility 20 to stop the charging. Specifically, the overheat protection unit 46 includes a thermostat 48 provided on the signal line. According to such a configuration, it is possible to suppress the conversion adapter 30 being in an overheated state with a simple configuration.

Further, according to the present embodiment, the conversion adapter 30 has a signal line connecting the terminal of the charging inlet 14 and the terminal of the charging plug 24, and the overheat protection unit 46 causes the vehicle 10 or the charging facility 20 to stop the charging by increasing the resistance value of the signal line when the temperature of the heat generating portion exceeds the threshold value. Specifically, the overheat protection unit 46 includes a thermally variable resistance 50 provided on the signal line. According to such a configuration, it is possible to suppress the conversion adapter 30 from being in an overheated state with a simple configuration.

What is claimed is:

1. A conversion adapter to be interposed between a charging inlet that receives power supply for charging a battery of a vehicle and a charging plug to be connected to a charging facility outside the vehicle, to enable power supply from the charging plug toward the charging inlet, the conversion adapter comprising an overheat protection unit that stops charging when a temperature of a predetermined heat generating portion exceeds a predetermined threshold value.

2. The conversion adapter according to claim 1, wherein:
the conversion adapter includes a signal line that connects a terminal of the charging inlet and a terminal of the charging plug; and
the overheat protection unit causes the vehicle or the charging facility to stop charging by shutting off the signal line when the temperature of the heat generating portion exceeds the threshold value.

3. The conversion adapter according to claim 2, wherein the overheat protection unit includes a thermostat provided on the signal line.

4. The conversion adapter according to claim 1, wherein:
the conversion adapter includes a signal line that connects a terminal of the charging inlet and a terminal of the charging plug; and
the overheat protection unit causes the vehicle or the charging facility to stop charging by increasing a resistance value of the signal line when the temperature of the heat generating portion exceeds the threshold value.

5. The conversion adapter according to claim 4, wherein the overheat protection unit includes a thermally variable resistor provided on the signal line.
